(19) United States
(12) Patent Application Publication
(10) Pub. No.: US 2002/0065358 A1
(43) Pub. Date: May 30, 2002

(54) METHOD OF INHIBITING SCALE FORMATION USING WATER-SOLUBLE POLYMERS HAVING PENDANT DERIVATIZED AMIDE FUNCTIONALITIES

(76) Inventors: PHILLIP W. CARTER, NAPERVILLE, IL (US); JOHN D. MORRIS, PLAINFIELD, IL (US); PETER E. REED, PLAINFIELD, IL (US); JIANSHENG TANG, SUDBURY, PA (US); JIN-SHAN WANG, ROCHESTER, NY (US); PAUL R. YOUNG, WHEATON, IL (US)

Correspondence Address: MICHAEL B MARTIN, PATENT & LICENSING DEPARTMENT, NALCO CHEMICAL COMPANY, ONE NALCO CENTER, NAPERVILLE, IL, 605631198

(21) Appl. No.: 09/333,384

(22) Filed: Jun. 15, 1999

Related U.S. Application Data
(63) Continuation-in-part of application No. 08/884,154, filed on Jun. 27, 1997, now Pat. No. 6,017,994.
Application No. 08/884,154 is a continuation-in-part of application No. 08/792,610, filed on Jan. 31, 1997, now Pat. No. 5,726,267.

(51) Int. Cl. C08K 3/00

(52) U.S. Cl. 524/555

(57) ABSTRACT

This invention is directed to a method of inhibiting scale formation in industrial water comprising adding to the industrial water an effective amount of a water-soluble polymer having pendant amide functionalities.

### CROSS REFERENCE TO RELATED APPLICATIONS

This is a continuation-in-part of co-pending U.S. Ser. No. 08/884,154, filed Jun. 27, 1997, which is a continuation-in-part of U.S. Ser. No. 08/792,610, filed Jan. 31, 1997, now U.S. Pat. No. 5,726,267.

### TECHNICAL FIELD

This invention concerns a method of inhibiting scale formation in industrial water using water-soluble polymers having pendant derivatized amide functionalities.

### BACKGROUND OF THE INVENTION

Most industrial waters contain inorganic salts formed from alkaline earth metal cations including calcium, barium and magnesium and anions including bicarbonate, carbonate, sulfate, oxalate, phosphate, silicate and fluoride as well as other salts of alkaline-earth metals and aluminum silicates such as the silicates derived from bentonitic, illitic and kaolinitic silts. When these salts are present in concentrations which exceed their solubility in the water, precipitates form until these product solubility concentrations are no longer exceeded.

Solubility product concentrations are exceeded for various reasons, such as partial evaporation of the water phase, change in pH, pressure or temperature, and the introduction of additional ions which form insoluble compounds with the ions already present in the solution.

The crystallization of these precipitates results in the formation of scales which may remain suspended in the water or form hard deposits which accumulate on the surface of any material which contacts the water. This accumulation prevents effective heat transfer, interferes with fluid flow, facilitates corrosive processes and harbors bacteria.

A primary detrimental effect associated with scale formation and deposition is the reduction of the capacity or bore of receptacles and conduits employed to store and convey the water. In the case of conduits used to convey scale-contaminated water, the impedance of flow resulting from scale deposition is an obvious consequence.

However, a number of equally consequential problems arise from utilization of scale-contaminated water. For example, scale deposits on the surfaces of storage vessels and conveying lines for process water may break loose and become entrained in and conveyed by the process water to damage and clog equipment through which the water is passed, e.g., tubes, valves, filters and screens. In addition, these deposits may appear in, and detract from, the final product derived from the process, such as paper formed from an aqueous suspension of pulp.

Furthermore, when the scale-contaminated water is involved in a heat exchange process, as either the “hot” or “cold” medium, scale will be formed upon the heat exchange surfaces contacted by the water. Such scale formation forms an insulating or thermal opacifying barrier which impairs heat transfer efficiency as well as impeding flow through the system. Thus, scale formation is an expensive problem in many industrial water systems, causing delay and expense resulting from shutdowns for cleaning and removal of the deposits.

Scales and scale deposits are generated and extended principally by means of crystal growth; and various approaches to reducing scale development have accordingly included inhibition of crystal growth, modification of crystal growth and dispersion of the scale-forming minerals.

The preparation and use of water soluble polymers having pendant amide functionalities is described in U.S. Pat. Nos. 4,680,339, 4,711,725, 4,731,419, 4,885,345, 4,921,903, 4,999,161, 5,084,520 and 5,049,310.

### SUMMARY OF THE INVENTION

This invention is directed to a method of inhibiting scale formation in industrial water comprising adding to the industrial water an effective amount of a water-soluble polymer comprising a mer unit of formula

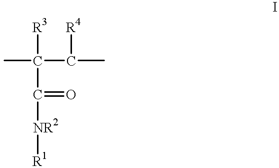

wherein

R¹ is selected from (CHR⁵CHR⁶Y)ₚ—(CHR⁷CHR⁸Z)_{q}—R⁹, CH(CH₃)CH₂(OCHR¹⁰CH₂)ᵣ—OR¹¹ and (CH₂)ₛR¹²;

R², R⁵, R⁶, R⁷, R⁸, R¹⁰ and R¹³ are independently selected from hydrogen and C₁-C₃ alkyl;

R³ and R⁴ are independently selected from hydrogen, —CO₂H and C₁-C₃ alkyl, or R³ and R⁴ together with the C atoms to which they are attached form a C₃-C₆ cycloalkyl;

R⁹ and R¹¹ are independently selected from hydrogen or C₁-C₂₀ alkyl;

R¹² is C₁-C₆ alkoxy or morpholino;

Y and Z are independently selected from O and NR¹³;

p and q are independently integers of 1-10;

r is an integer of 1-50; and

s is an integer of 1-10,

and optionally further comprising one or more mer units selected from the group consisting of acrylic acid, methacrylic acid, acrylamide, methacrylamide, maleic anhydride, itaconic acid, vinyl sulfonic acid, styrene sulfonate, N-tertbutylacrylamide, butoxymethylacrylamide, N,N-dimethylacrylamide, sodium acrylamidomethyl propane sulfonic acid, vinyl alcohol, vinyl acetate, N-vinyl pyrrolidone, maleic acid, and combinations thereof.

### DETAILED DESCRIPTION OF THE INVENTION

Definitions of Terms

As used herein the following terms shall have the following meanings:

“Precipitate” means a solid or gel which separates from the industrial water or process water as defined herein. The precipitate forms when the material is present in the water in a concentration which exceeds its solubility. Precipitation is caused by various events including partial evaporation of the water, change in pH, pressure or temperature, or the introduction of additional materials which form insoluble compounds when combined with the materials already present in the water.

“Scale” means any solid, including precipitates as defined herein, found either suspended in the industrial or process water or deposited on a surface which contacts the water. “Scale” includes but is not limited to solid inorganic salts, corrosion products or organic-based biofilms. Typical scales include calcium phosphate, zinc phosphate, iron hydroxide, aluminum hydroxide, zinc (hydr)oxide, calcium sulfate, barium sulfate, clay, silt, magnesium carbonate, magnesium phosphate, calcium carbonate, calcium and magnesium salts of HEDP and calcium and magnesium salts of PBTC, magnesium silicate, calcium sulfate, calcium oxalate, and the like.

“Inhibiting scale formation” as used herein also encompasses preventing scale formation. Without being limited by theory, it is understood that polymers described herein inhibit scale formation by any of various mechanisms or combinations thereof including stabilizing solutions which contain inorganic salts against precipitation of the salts, preventing scale formation by dispersing the precipitated salts, interfering with the crystal structure of the scale, thereby making the scale more dispersible, and facilitating the dispersion of other suspended material.

“Industrial water” means water used in industrial systems and processes.

“Process water” means water used in any industrial process in which the water contacts products or intermediates. Process water is typically used as a carrier for clay (mining applications), fiber (paper applications), or crude oil (oilfield applications) or for washing or removing impurities from the industrial process. “Process water”, as used herein, includes, but is not limited to, mining process water, pulp & paper process water and oilfield process water.

“Industrial system” means any industrial process which utilizes water. The system can contain primarily aqueous fluids, or primarily non-aqueous fluids which also contain water. Such systems are commonly found in industrial processes which utilize boilers or cooling water towers.

“Recirculating system” means a system where a fluid element is reused, making many passes through the same unit operation.

“Cooling water” means water used to remove heat by means of a heat exchange process in any industrial process such as heat exchanger unit operations. The cooling water may contain additional chemicals including biocides, corrosion inhibitors, additional scale inhibitors or anti-foaming agents which are added to improve the performance of the cooling system. To treat water in a cooling water system, the compounds are added to the cooling tower basin or at any other location wherein good mixing can be achieved in a short time.

Representative additives used to reduce scale formation in cooling water include biopolymers (tannins, lignins) synthetic polymers (water-soluble poly(acrylates), poly(methacrylates), poly(maleates)) and water-soluble organophosphorous compounds (organophosphates or organophosphonates such as 1-hydroxyethylidene-1,1-diphosphonic acid, 2-phosphonobutane-1,2,4-tricarboxylic acid, and aminotris(methylenephosphonic acid)).

“Heat exchange process” means any process where heat is transferred from one body or fluid to another across a thermally conductive barrier, said barrier commonly being called the heat exchange surface. The heat exchange surface is typically a metal surface such as stainless steel, mild steel and copper alloys such as brass among others.

“Silt” means any particulate matter such as sand, dust, dirt, mud, etc., originally wind-borne or water-borne, present in industrial water. It is often comprised of aluminosilicate minerals (clay).

“Clay” means a hydrolyzed aluminum silicate of general formula Al₂O₃SiO₂xH₂O which is present in soils, including bentonitic, kaolinitic and illitic clay.

“Corrosion inhibitor” means any substance which reduces the rate of metal corrosion. “Yellow metal corrosion inhibitor” means any substance which reduces the rate of corrosion of metals containing copper. “Ferrous metal corrosion inhibitor” means any substance which reduces the rate of corrosion of metals containing iron. Representative corrosion inhibitors include hydroxyethylidene-1,1-diphosphonic acid (HEDP), 2-phosphonobutane-1,2,4-tricarboxylic acid (PBTC), 2-hydroxyethylimine bis(methylene phosphonic acid) N-oxide (EBO), methylene diphosphonic acid (MDP), hexamethylenediamine-N,N,N′,N′-tetra(methylene phosphonic acid), amino and tris(methylene phosphonic acid), phosphorus-containing inorganic chemicals such as orthophosphates, pyrophosphates, polyphosphates, organophosphonates such as 2-hydroxy-2-phosphonoacetic acid, hydroxycarboxylic acids and their salts such as gluconic acids; Zn²⁺, Ce²⁺, MoO₄²⁻, WO₄²⁻, nitrites and azoles such as benzotriazole and tolyltriazole, and the like.

“Biocide” means any substance which reduces the rate of growth of microbiological organisms or reduces the rate of biofilm formation. Representative biocides include oxidizing biocides such as stabilized bleach, chlorine and hypobromite and bromine and non-oxidizing biocides such as glutaraldehyde, isothiazolones (mixtures of 5-chloro-2-methyl-4-isothiazolin-3-one and 2-methyl-4-isothiazolin-3-one), sulfamic acid-stabilized bleach and sulfamic acid-stabilized bromine.

“Hard water” means water containing over 100 ppm of divalent metal cations.

“Extremely hard water” means water containing over 500 ppm of divalent metal cations.

“Dispersant” means any material which which reduces the rate of scale deposition, typically by enhancing the stability of the suspended scales. Representative dispersants include water soluble acrylate based polymers such as polyacrylic acid, poly (acrylamidomethyl propane sulfonic acid/acrylic acid (AMPS-AA copolymer), and copolymers of maleic acid and sodium syrene sulfonate.

“Alkyl” means a monovalent group derived from a straight or branched chain saturated hydrocarbon by the removal of a single hydrogen atom. Representative alkyl groups include methyl, ethyl, n- and iso-propyl, n-, sec-, iso- and tert-butyl, and the like.

“Alkoxy” and “alkoxyl” mean an alkyl group, as defined above, attached to the parent molecular moiety through an oxygen atom. Representative alkoxy groups include methoxyl, ethoxyl, propoxyl, butoxyl, and the like.

Preferred Embodiments

The polymers described herein contain amide mer units functionalized with pendant groups. These pendant groups confer favorable properties to the polymer for use as scale inhibitors. The polymers are produced by polymerization using specific monomers, such as might be produced by the copolymerization of acrylic acid with an N-methoxy propyl acrylamide, methoxyethoxy acrylate, methoxyethoxy maleate or N-methoxypropyl acrylate comonomer. The polymer so produced would contain a hydrophilic backbone with pendant groups.

Alternatively, pendant groups are introduced into the polymer after polymerization. For example, polyacrylic acid can be amidated with an ethoxylated/propoxylated amine, such as those available from Huntsman Corporation, Houston, Tex., under the trade name Jeffamine series, to produce a polymer with a hydrophilic backbone and ethyleneoxy/propyleneoxy pendant groups. During the amidation process, cyclic imide structures might form between two adjacent carboxylate or carboxamide units on the polymer backbone. Polymers suitable for use in this invention also encompass these cyclic imides.

The polymers may be utilized in conjunction with other agents, for example biocides, corrosion inhibitors, scale inhibitors, dispersants, and additives. Such a combination may exert a synergistic effect in terms of corrosion inhibitors, scale inhibition, dispersancy and bacterium control.

The polymers are also effectively utilized in conjunction with other polymeric treating agents, for example anionic polymers of under 200,000 MW. Such polymers include acrylic, methacrylic or maleic acid containing homo-, co- or ter-polymers.

Examples of other scale inhibitors that can be used in conjunction with the polymers include polyacrylates, polymethacrylates, copolymers of acrylic acid and methacrylate, copolymers of acrylic acid and acrylamide, poly(maleic acid) copolymers of acrylic acid and maleic acid, polyesters, polyaspartic acid, functionalized polyaspartic acid, terpolymers of acrylic acid, and acrylamide/sulfomethylated acrylamide copolymers, HEDP (1-hydroxyethylidene-1,1-diphosphonic acid), PBTC (2-phosphonobutane-1,2,4-tricarboxylic acid), and AMP (amino tri(methylene phosphonic acid).

Polymers have a molecular weight of from about 1,000 to about 1,000,000 are preferred, polymers having a molecular weight of from about 5,000 to about 100,000 are more preferred.

Preferred polymers are those wherein from about 1 to about 75% of the total number of mer units are mer units of formula I. Polymers wherein from about 5 to about 50% of the total number of mer units are mer units of formula I are more preferred.

The polymers are added to the industrial water in an amount of from about 0.5 ppm to about 500 ppm. Preferably, the polymers are added in an amount of from about 2 ppm to about 100 ppm. More preferably, the polymers are added in an amount of from about 5 ppm to about 50 ppm.

In a preferred aspect of this invention, the industrial water is cooling water.

In another preferred aspect of this invention, the cooling water contains a biocide.

In another preferred aspect of this invention, the cooling water contains corrosion inhibitors.

In another preferred aspect of this invention, the cooling water contains additional scale inhibitors.

In another preferred aspect of this invention, the scale is selected from the group consisting of calcium phosphate, zinc phosphate, iron hydroxide, zinc (hydr)oxide, aluminum hydroxide, calcium sulfate, barium sulfate, clay, silt, magnesium carbonate, magnesium phosphate, magnesium silicate, calcium carbonate and calcium oxalate.

In another preferred aspect of this invention, the industrial water is industrial process water selected from the group consisting of mining process water, pulp and paper process water and oilfield process water.

In a more preferred aspect of this invention, the scale is selected from calcium phosphate, calcium carbonate, barium sulfate, calcium oxalate, magnesium silicate and zinc (hydr)oxide.

In a another more preferred aspect of this invention, the water-soluble polymer comprises acrylic acid, acrylamide and a mer unit of formula

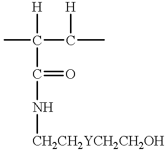

wherein Y is O or NH.

In another more preferred aspect of this invention, the water-soluble polymer comprises acrylic acid, maleic acid and a mer unit of formula

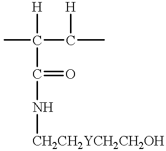

wherein Y is O or NH.

In another more preferred aspect of this invention, the water-soluble polymer comprises acrylic acid and a mer unit of formula

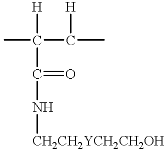

wherein Y is O or NH.

In another more preferred aspect of this invention, the water-soluble polymer comprises acrylic acid, acrylamide and a mer unit of formula

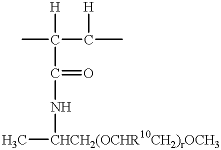

wherein R¹⁰ is hydrogen or methyl and r is an integer of 10-21.

In another more preferred aspect of this invention, the water-soluble polymer comprises acrylic acid and a mer unit of formula

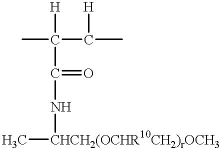

wherein R¹⁰ is hydrogen or methyl and r is an integer of 10-21.

In another more preferred aspect of this invention, the water-soluble polymer comprises acrylic acid, maleic acid and a mer unit of formula

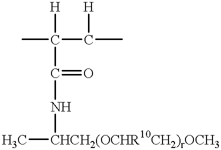

wherein R¹⁰ is hydrogen or methyl and r is an integer of 10-21.

In another more preferred aspect of this invention, the water-soluble polymer comprises acrylic acid, acrylamide and a mer unit of formula

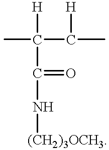

In another more preferred aspect of this invention, the water-soluble polymer comprises acrylic acid and a mer unit of formula

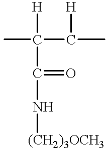

In another more preferred aspect of this invention, the water-soluble polymer comprises acrylic acid, maleic acid and a mer unit of formula

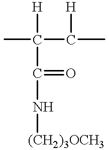

The foregoing may be better understood by reference to the following Examples which are presented for purposes of illustration and are not intended to limit the scope of the invention.

### EXAMPLE 1

The synthesis of an ammonium acrylate/N-(hydroxyethoxy)ethyl acrylamide copolymer was effected using following reactants in the following amounts:

| Reactant | Amount (g) |
|---|---|
| Poly(AA), 25.6 weight % in water | 100.00 |
| Aminoethoxyethanol | 11.92 |
| Ammonium Hydroxide, 29 weight % | 2.51 |

To prepare the polymer, poly(AA) (25.6 weight percent poly(acrylic acid) solution, pH=3.8, 16,000 MW) was placed in a beaker, which was cooled using an ice bath. Aminoethoxyethanol (available from Huntsman Petrochemical Co., in Houston, Tex.) was added dropwise into the poly(acrylic acid)/water solution with vigorous stirring. Afterwards, the solution was stirred for another 15 minutes. Aqueous caustic was added to adjust the pH to about 5. Next, the reaction mixture was transferred into a 300 mL Parr reactor with a pressure rating of at least 800 psi. The reactor then was assembled and purged with nitrogen for approximately 60 minutes. The Parr reactor was then slowly heated to 160° C. (or less, as the case may be) and held at that temperature for 8 hours (or more, as the case may be). Afterwards, the reactor was cooled to room temperature and the pressure released. The product was then transferred to storage.

¹³C NMR confirmed product formation. The content of N-(hydroxyethoxy)ethyl acrylamide was 21 mole %, based on the total moles of mer units on the polymer, which represents both secondary amide and imide mer units. The polymer's molecular weight was 24,000.

### EXAMPLE 2

The synthesis of an ammonium acrylate/acrylamide/N-(hydroxyethoxy)ethyl acrylamide terpolymer was effected in the following manner using the reactants in the amounts listed below:

| Reactant | Amount (g) |
|---|---|
| Poly(NH₄AA/AcAm), 50/50 mol % | 300.00 |
| solution polymer, 38.2 weight % | |
| Aminoethoxyethanol | 114.00 |

To prepare the polymer, Poly(NH₄AA/AcAm) (50/50 mol % ammonium acrylate/acrylamide copolymer, 38.2 weight percent, pH=5.5, 33,000 MW) was placed in a beaker, which was cooled using an ice bath. Aminoethoxyethanol (available from Huntsman Petrochemical Co., in Houston, Tex.) was added dropwise into the above water solution with vigorous stirring (pH=10.1). Afterwards, the solution was stirred for another 15 minutes. Next, the reaction mixture was transferred into a 600 mL Parr reactor with a pressure rating of at least 800 psi. The reactor then was assembled and purged with nitrogen for approximately 60 minutes. The Parr reactor was then slowly heated to 138° C. and held at that temperature for 14 hours. Afterwards, the reactor was cooled to room temperature and the pressure released. The product was then transferred to storage.

¹³C NMR confirmed product formation. The content of N-(hydroxyethoxy)ethyl acrylamide was 33.3 mole %, based on the total moles of mer units on the polymer. The polymer had a molecular weight of 35,000, and a mole ratio of N-(hydroxyethoxy)ethyl acrylamide/acrylic acid/acrylamide of about 33/41/26.

### EXAMPLE 3

The synthesis of a sodium acrylate/acrylamide/N-(hydroxyethoxy)ethyl acrylamide terpolymer was effected in the following manner with the reactants in the amounts listed below:

| Reactant | Amount (g) |
|---|---|
| Poly(NaAA/AcAm), 50/50 mol % | 100.00 |
| solution polymer, 32.0 weight % | |
| Aminoethoxyethanol | 32.00 |
| Sulfuric Acid (95%) | 11.5 |

To prepare the polymer, Poly(NaAA/AcAm) (50/50 mol % sodium acrylate/acrylamide copolymer, 32.0 weight %, pH=5.2, 11,000 MW) was placed in a beaker, which was cooled using an ice bath. Aminoethoxyethanol (available from Huntsman Petrochemical Co., in Houston, Tex.) was added dropwise into the above water solution with vigorous stirring. Afterwards, the solution was stirred for another 15 minutes. Sulfuric acid was added to adjust the pH to about 5.6. Next, the reaction mixture was transferred into a 300 mL Parr reactor with a pressure rating of at least 800 psi. The reactor then was assembled and purged with nitrogen for approximately 60 minutes. The Parr reactor was then slowly heated to 138° C. and held at that temperature for 12 hours. Afterwards, the reactor was cooled to room temperature and the pressure released. The product was then transferred to storage.

¹³C NMR confirmed product formation. The content of N-(hydroxyethoxy)ethyl acrylamide was 33 mole %, based on the total moles of mer units on the polymer. The mole ratio was about 42/22/33 of acrylic acid/acrylamide(including 3% imide mer units)/N-(hydroxyethoxy)ethyl acrylamide (including imide mer units). The product polymer had a molecular weight of 12,000.

### EXAMPLE 4

The synthesis of a sodium acrylate/acrylamide/N-Methoxypropyl acrylamide terpolymer was effected in the following manner with the reactants in the amounts listed below:

| Reactant | Amount(g) |
|---|---|
| Poly(NaAA/AcAm), 50/50 mol % | 100.00 |
| solution polymer, 32.0 weight % | |
| Methoxypropylamine | 23.32 |
| Sulfuric Acid (95%) | 11.23 |

To prepare the polymer, Poly(NaAA/AcAm) (50/50 mol %, 32.0 weight %, pH=5.2, 11,000 MW) was placed in a beaker, which was cooled using an ice bath. Methoxypropylamine (available from Aldrich Chem. Co., in Milwaukee, Wis.) was added dropwise into the above water solution with vigorous stirring. Afterwards, the solution was stirred for another 15 minutes. Sulfuric acid was added to adjust the pH to about 5.6. Next, the reaction mixture was transferred into a 300 mL Parr reactor with a pressure rating of at least 800 psi. The reactor then was assembled and purged with nitrogen for approximately 60 minutes. The Parr reactor was then slowly heated to 138° C. and held at that temperature for 12 hours. Afterwards, the reactor was cooled to room temperature and the pressure released. The product was then transferred to storage.

¹³C NMR confirmed product formation. The content of N-methoxypropyl acrylamide was 34.2 mole %, based on the total moles of mer units on the polymer. The mole ratio of the product was about 41/17/34 which represents acrylic acid/acrylamide (including 6% imide mer units)/methoxypropyl acrylamide (including imide mer units). The product's molecular weight was 11,000.

### EXAMPLE 5

The synthesis of a sodium acrylate/acrylamide/N-hydroxy(ethylamino)ethyl acrylamide terpolymer was effected in the following manner with the reactants in the amounts listed below:

| Reactant | Amount(g) |
|---|---|
| Poly(NaAA/AcAm), 50/50 mol % | 80.00 |
| solution polymer, 24.0 weight % | |
| (Aminoethylamino)ethanol | 19.02 |
| Sulfuric Acid (95%) | 12.23 |

To prepare the polymer, Poly(NaAA/AcAm) (50/50 mol %, 24.0 weight %, pH=3.5, 15,000 MW) was placed in a beaker, which was cooled using an ice bath. (Aminoethylamino)ethanol (available from Aldrich Chem. Co., in Milwaukee, Wis.) was added dropwise into the above water solution with vigorous stirring. Afterwards, the solution was stirred for another 15 minutes. Sulfuric acid was added to adjust the pH to about 5.6. Next, the reaction mixture was transferred into a 300 mL Parr reactor with a pressure rating of at least 800 psi. The reactor then was assembled and purged with nitrogen for approximately 60 minutes. The Parr reactor was then slowly heated to 138° C. and held at that temperature for 14 hours. Afterwards, the reactor was cooled to room temperature and the pressure released. The product was then transferred to storage.

¹³C NMR confirmed product formation. The content of N-hydroxy(ethylamino) ethyl acrylamide was 46 mole %, based on the total moles of mer units on the polymer, representing both secondary amide and imide mer units. The mole ratio of the product was about 46/51/3 N-hydroxy(ethylamino)ethyl acrylamide/acrylic acid/acrylamide. The product polymer's molecular weight was 15,000.

### EXAMPLE 6

The synthesis of an acrylic acid/acrylamide/N-(hydroxyethoxy)ethyl acrylamide terpolymer was effected in the following manner with the reactants in the amounts listed below:

| Reactant | Amount(g) |
|---|---|
| Poly(AcAm), 50 weight % | 50.00 |
| Aminoethoxyethanol | 12.9 |
| Deionized water | 50.0 |
| Sulfuric Acid (95%) | 6.1 |

To prepare the polymer, Poly(AcAm) (50 wt %, available from Aldrich Chemical Co., 10,000 MW) was placed in a beaker, which was cooled using an ice bath. Aminoethoxyethanol (available from Huntsman Petrochemical Co., in Houston, Tex.) was added dropwise into the above water solution with vigorous stirring. Afterwards, the solution was stirred for another 15 minutes. Sulfuric acid was added to adjust the pH to about 5.6. Next, the reaction mixture was transferred into a 300 mL Parr reactor with a pressure rating of at least 800 psi. The reactor then was assembled and purged with nitrogen for approximately 60 minutes. The Parr reactor was then slowly heated to 138° C. and held at that temperature for 14 hr. Afterwards, the reactor was cooled to room temperature and the pressure released. The product was then transferred to storage.

¹³C NMR confirmed product formation. The content of N-(hydroxyethoxy) ethyl acrylamide was 19.6 mole %, based on the total moles of mer units on the polymer. The product's mole ratio was about 32/44/20 which represents acrylic acid/acrylamide/N-(hydroxyethoxy) ethyl acrylamide.

### EXAMPLE 7

The synthesis of an ammonium acrylate/N-Methoxypropyl acrylamide copolymer was effected in the following manner with the reactants in the amounts listed below:

| Reactant | Amount(g) |
|---|---|
| Poly(AA), 25.6 weight % in water | 100.00 |
| Methxypropylamine | 10.09 |
| Ammonium Hydroxide, | 0.86 |
| 29 weight % in water | |

To prepare the polymer, Poly(AA)(32.0 wt %, pH=3.3, 15,000 MW) was placed in a beaker, which was cooled using an ice bath. Methoxypropylamine (available from Aldrich Chem. Co., in Milwaukee, Wis.) was added dropwise into the above water solution with vigorous stirring. Afterwards, the solution was stirred for another 15 minutes. Aqueous caustic was added to adjust the pH to about 5. Next, the reaction mixture was transferred into a 300 mL Parr reactor with a pressure rating of at least 800 psi. The reactor then was assembled and purged with nitrogen for approximately 60 minutes. The Parr reactor was then slowly heated to 160° C. and held at that temperature for 8 hours. Afterwards, the reactor was cooled to room temperature and the pressure released. The product was then transferred to storage.

¹³C NMR confirmed product formation. The content N-methoxypropyl acrylamide was 22.4 mole %, based on the total moles of mer units on the polymer, which represents both secondary amide and imide mer units. The polymer's molecular weight was 15,000.

### EXAMPLE 8

The synthesis of an acrylic acid/acrylamide/N-Methoxypropyl acrylamide terpolymer was effected in the following manner with the reactants in the amounts listed below:

| Reactant | Amount(g) |
|---|---|
| Poly(AcAm), 50 weight % in water | 100.00 |
| Methoxypropylamine | 10.99 |
| Sulfuric Acid (95%) | 6.75 |
| Sodium Hydroxide (50 weight %) | 1.8 |

To prepare the polymer, Poly(AcAm) (50.0 wt %, Available from Aldrich Chemical Co., 10,000 MW) was placed in a beaker, which was cooled using an ice bath. Methoxypropylamine (available from Aldrich Chemical Co., in Milwaukee, Wis.) was added dropwise into the above water solution with vigorous stirring. Afterwards, the solution was stirred for another 15 minutes. Aqueous caustic was added to adjust the pH to about 5.6. Next, the reaction mixture was transferred into a 300 mL Parr reactor with a pressure rating of at least 800 psi. The reactor then was assembled and purged with nitrogen for approximately 60 minutes. The Parr reactor was then slowly heated to 138° C. and held at that temperature for 12 hours. Afterwards, the reactor was cooled to room temperature and the pressure released. The product was then transferred to storage.

¹³C NMR confirmed product formation. The content N-methoxypropyl acrylamide was 20.3 mole %, based on the total moles of mer units on the polymer, which represents both secondary amide and imide mer units. The product's mole ratio was about 33.8/45/20 which represents acrylic acid/acrylamide/N-(methoxypropyl) acrylamide. The polymer's molecular weight was 18,500.

### EXAMPLE 9

The synthesis of an acrylic acid/acrylamide/N-Methoxyethyl acrylamide terpolymer was effected in the following manner with the reactants in the following manner with the reactants in the amounts listed below:

| Reactant | Amount(g) |
|---|---|
| Poly(AA/AcAm), 31.4 weight % in water | 100 |
| Methoxyethylamine | 19.65 |
| Sulfuric Acid (95%) | 10.20 |

To prepare the polymer, Poly(A/AcAm) (31.4 wt %, 11,000 MW) was placed in a beaker, which was cooled using an ice bath. Methoxyethylamine (available from Aldrich Chemical Co., in Milwaukee, Wis.) was added dropwise into the above water solution with vigorous stirring. Afterwards, the solution was stirred for another 15 minutes. The pH of the reaction mixture was measured using water-wet pH strips. Aqueous caustic was added to adjust the pH to about 5.6. Next, the reaction mixture was transferred into a 300 mL parr reactor with a pressure rating of at least 800 psi. The reactor then was assembled and purged with nitrogen for approximately 60 minutes. The Parr reactor was then slowly heated to 138° C. and held at that temperature for 12 hours. Afterwards, the reactor was cooled to room temperature and the pressure released. The product was then transferred to storage.

¹³C NMR confirmed product formation. The content N-methoxypropyl acrylamide was 40.8 mole %, based on the total moles of mer units on the polymer, which represents both secondary amide and imide mer units. The product's mole ratio was about 40/14/41 which represents acrylic acid/acrylamide/N-(methoxypropyl) acrylamide. The polymer's molecular weight was 11,000.

### EXAMPLE 10

The synthesis of a sodium acrylate/acrylamide/N-alkoxylated acrylamide copolymer was effected in the following manner with the reactants in the amounts listed below:

| Reactant | Amount(g) |
|---|---|
| Poly(AA/AcAm), 50/50 mole % | 100 |
| 43.8 weight % in water | |
| Jeffamine M-1000 | 60 |
| Sodium Hydroxide (50 weight %) | 11.78 |
| Deionized Water | 100 |

To prepare the polymer, Poly(A/AcAm) (43.8 wt %, pH=4.0, 18,000 MW) was placed in a beaker, which was cooled using an ice bath. Jeffamine M-1000 (available from Texaco Chemical Co.) was added dropwise into the above water solution with vigorous stirring. Afterwards, the solution was stirred for another 15 minutes. Aqueous caustic was added to adjust the pH to about 6.9. Next, the reaction mixture was transferred into a 300 mL parr reactor with a pressure rating of at least 800 psi. The reactor then was assembled and purged with nitrogen for approximately 60 minutes. The Parr reactor was then slowly heated to 150° C. and held at that temperature for 5 hours. Afterwards, the reactor was cooled to room temperature and the pressure released. The product was then transferred to storage.

### EXAMPLE 11

The synthesis of a sodium acrylate/N-hydroxy(ethylamino)ethyl acrylamide terpolymer was effected in the following manner with the reactants in the amounts listed below:

| Reactant | Amount (g) |
|---|---|
| Poly(AA), 27.0 weight % in water | 100.00 |
| (Aminoethylamino)ethanol | 12.89 |
| Sulfuric Acid (95%) | 0.6 |

To prepare the polymer, Poly(AA) (27.0 weight %, pH=3.4, 17,000 MW) was placed in a beaker, which was cooled using an ice bath. (Aminoethylamino)ethanol (available from Aldrich Chem. Co., in Milwaukee, Wis.) was added dropwise into the above water solution with vigorous stirring. Afterwards, the solution was stirred for another 15 minutes. Sulfuric acid was added to adjust the pH to about 5.6. Next, the reaction mixture was transferred into a 300 mL Parr reactor with a pressure rating of at least 800 psi. The reactor then was assembled and purged with nitrogen for approximately 60 minutes. The Parr reactor was then slowly heated to 138° C. and held at that temperature for 14 hours. Afterwards, the reactor was cooled to room temperature and the pressure released. The product was then transferred to storage.

¹³C NMR confirmed product formation. The content of N-hydroxy(ethylamino) ethyl acrylamide was about 30 mole %, based on the total moles of mer units on the polymer, representing both secondary amide and imide mer units. The product's mole ratio was approximately 70/30 which represents acrylic acid/N-(hydroxyethylamino) ethyl acrylamide. The product polymer's molecular weight was 32,000.

### EXAMPLE 12

The activity of polymers for calcium phosphate scale inhibition were evaluated in the following manner.

An acidic stock solution was prepared containing calcium chloride, magnesium sulfate, and phosphoric acid. Aliquots of this stock solution were transferred to flasks so that on dilution, the final concentration of calcium was 750 or 1500 ppm as CaCO₃. Iron or aluminum were added in the 750 ppm Ca tests. The appropriate volume of inhibitor was added to give 20 ppm polymer for the 1500 ppm Ca tests, 25 ppm polymer for the iron tests or 30 ppm polymer for the aluminum tests. D1 water was added, and the flasks were heated to 70° C. in a water bath. Stirring was maintained at 250 rpm with 1″ stir bars.

Once the solutions were at temperature, the pH was adjusted to 8.5. pH was checked frequently to maintain 8.5. Filtered samples were taken after four hours. Then, 100 ml of the solution was taken and boiled for 10 minutes in a covered flask. The volume was brought back to 100 ml with D1 water, and filtered samples were taken again. Standard calorimetric analyses determined ortho phosphate concentration in the samples. Percent phosphate is reported as 100*P(filt)/P(unfilt). When no polymer was added, 4-6% filterable phosphate was obtained.

Percent inhibition numbers above 80% indicate exceptional dispersant activity. Polymers which disperse the phosphate in this test are observed to prevent calcium phosphate scale in recirculating cooling water systems under similar high stress conditions. Numbers less than about 40% indicate poor dispersant activity. Such polymers may or may not work under milder conditions (softer, cooler water), but do allow scale to form under high stress conditions. Polymers with intermediate activity are still good dispersants for low stress conditions, but will lose activity at higher stress.

TABLE I
Calcium Phosphate Dispersancy Test - High Stress Conditions

| | Percent Inhibition at 20 ppm Polymer | | |
|---|---|---|---|
| Polymer | Ca Test | Fe Test | Al Test |
| A¹ | 37 | 46 | 34 |
| B² | 33 | - - - | - - - |
| C³ | 60 | - - - | 20 |
| D⁴ | 89 | - - - | - - - |
| E⁵ | 87 | 43 | 33 |
| F⁶ | 82 | 44 | 58 |
| G⁷ | 70 | 57 | 46 |
| H⁸ | 53 | - - - | - - - |
| I⁹ | 63 | - - - | - - - |
| J¹⁰ | 71 | - - - | - - - |
| K¹¹ | 26 | - - - | - - - |

¹conventional treatment 1, sulfonated p(AA/AcAm)
²polymer prepared according to a procedure similar to Example 10; 10/40/50 mole ratio of Jeffamine/AA/AcAm, 60,000 MW
³polymer prepared according to a procedure similar to Example 10; 20/40/40 mole ratio of Jeffamine/AA/AcAm, 10,000 MW
⁴polymer prepared according to a procedure similar to Example 10; 40/40/20 mole ratio of Jeffamine/AA/AcAm, 20,000 MW
⁵polymer prepared according to a procedure similar to Example 3
⁶polymer prepared according to a procedure similar to Example 1
⁷polymer prepared according to the procedure of Example 2; 33/41/26 mole ratio of AEE/AA/AcAm
⁸polymer prepared according to the procedure of Example 4; 34/41/17 mole ratio of MOPA/AA/AcAm
⁹polymer prepared according to the procedure of Example 5; 51/46/3 mole ratio of AA/AEAE/AcAm
¹⁰polymer prepared according to the procedure of Example 9
¹¹conventional treatment 2, p(AA/AcAm) available from Nalco Chemical Co., Naperville, IL

### EXAMPLE 13

The following dispersancy test procedure was utilized to obtain the results shown in Table II. 200 mL of a test solution containing 20 ppm of a polymer dispersant and 20 ppm of PBTC dissolved in distilled water was prepared. Then the test solution was added to a 250 mL erlenmeyer flask magnetically stirred at 40° C. Hardness and m-alkalinity are added to the solution over seven minutes to achieve a final solution composition (ppm as Ca CO₃) of 700 ppm Ca²⁺, 350 ppm Mg²⁺, and 700 ppm CO₃²⁻. As calcium carbonate precipitation proceeds, the particle monitor (Chemtrac Systems Inc., PM 2700 RS) responds to the fraction of calcium carbonate particles greater than 0.5 microns in diameter. The more effectively dispersed the calcium carbonate particles, the lower the fraction of large particle agglomerates. Better performing test solutions are indicated by (1) lower particle monitor intensities, and (2) intensity maxima achieved at longer times (60 minute limit).

Examples 1 and 7 are the best performing dispersants for preventing calcium carbonate particle agglomeration evidenced by (1) the smallest particle monitor intensity and (2) requiring longer times to achieve their maximum signal response. Traditional dispersants (polyacrylic acid) provide improved dispersancy over the blank, but do not perform as well as the examples cited.

TABLE II

| Dispersant | | |
|---|---|---|
| (20 ppm total actives) | Particle Monitor Intensity (time) | |
| Blank¹ | 100 (12 | minutes) |
| Poly(acrylic acid) | 57 (45 | minutes) |
| L² | 15 (55 | minutes) |
| M³ | 12 (60 | minutes) |

¹20 ppm PBTC
²polymer prepared according to the procedure of Example 1
³polymer prepared according to the procedure of Example 7

Changes can be made in the composition, operation and arrangement of the method of the present invention described herein without departing from the concept and scope of the invention as defined in the following claims:

1. A method of inhibiting scale formation in industrial water comprising adding to the industrial water an effective amount of a water-soluble polymer comprising a mer unit of formula 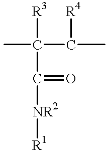
wherein
R¹ is selected from (CHR⁵CHR⁶Y)ₚ—(CHR⁷CHR⁸Z)_{q}—R⁹, CH(CH₃)CH₂(OCHR¹⁰CH₂)ᵣ—OR¹¹ and (CH₂)ₛR¹²;
R², R⁵, R⁶, R⁷, R⁸, R¹⁰ and R¹³ are independently selected from hydrogen and C₁-C₃ alkyl;
R³ and R⁴ are independently selected from hydrogen, —CO₂H and C₁-C₃ alkyl, or R³ and R⁴ together with the C atoms to which they are attached form a C₃-C₆ cycloalkyl;
R⁹ and R¹¹ are independently selected from hydrogen or C₁-C₂₀ alkyl;
R¹² is C₁-C₆ alkoxy or morpholino;
Y and Z are independently selected from O and NR¹³;
p and q are independently integers of 1-10;
r is an integer of 1-50; and
s is an integer of 1-10,
and optionally further comprising one or more mer units selected from the group consisting of acrylic acid, methacrylic acid, acrylamide, methacrylamide, maleic anhydride, itaconic acid, vinyl sulfonic acid, styrene sulfonate, N-tertbutylacrylamide, butoxymethylacrylamide, N,N-dimethylacrylamide, sodium acrylamidomethyl propane sulfonic acid, vinyl alcohol, vinyl acetate, N-vinyl pyrrolidone, maleic acid, and combinations thereof.

2. The method of claim 1 wherein the industrial water is cooling water.

3. The method of claim 1 wherein the scale is selected from the group consisting of calcium phosphate, zinc phosphate, iron hydroxide, aluminum hydroxide, calcium sulfate, barium sulfate, clay, silt magnesium carbonate, magnesium phosphate and calcium carbonate.

4. The method of claim 2 wherein the cooling water contains a biocide.

5. The method of claim 2 wherein the cooling water contains corrosion inhibitors.

6. The method of claim 2 wherein the cooling water contains additional scale inhibitors.

7. The method of claim 1 wherein the industrial water is industrial process water selected from the group consisting of mining process water, pulp and paper process water and oilfield process water.

8. The method of claim 1 wherein the water-soluble polymer comprises acrylic acid, acrylamide and a mer unit of formula 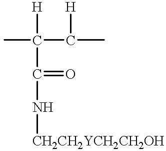
wherein Y is O or NH.

9. The method of claim 1 wherein the water-soluble polymer comprises acrylic acid, maleic acid and a mer unit of formula 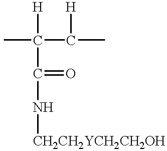
wherein Y is O or NH.

10. The method of claim 1 wherein the water-soluble polymer comprises acrylic acid and a mer unit of formula 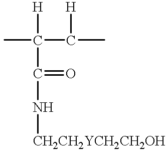
wherein Y is O or NH.

11. The method of claim 1 wherein the water soluble polymer comprises acrylic acid, acrylamide and a mer unit of formula 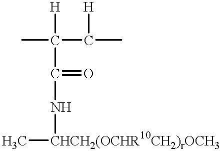
wherein R¹⁰ is hydrogen or methyl and r is an integer of 10-21.

12. The method of claim 1 wherein the water soluble polymer comprises acrylic acid and a mer unit of formula 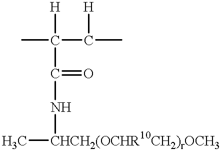
wherein R¹⁰ is hydrogen or methyl and r is an integer of 10-21.

13. The method of claim 1 wherein the water soluble polymer comprises acrylic acid, maleic acid and a mer unit of formula 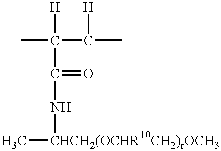
wherein R¹⁰ is hydrogen or methyl and r is an integer of 10-21.

14. The method of claim 1 wherein the water soluble polymer comprises acrylic acid, acrylamide and a mer unit of formula

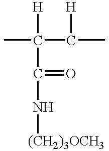

15. The method of claim 1 wherein the water soluble polymer comprises acrylic acid and a mer unit of formula

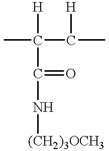

16. The method of claim 1 wherein the water soluble polymer comprises acrylic acid, maleic acid and a mer unit of formula [chemical structure]
